(19) United States
(12) Patent Application Publication
(10) Pub. No.: US 2008/0147503 A1
(43) Pub. Date: Jun. 19, 2008

(54) Movie distribution method

(76) Inventor: Lowry Brooks, Randallstown, MD (US)

Correspondence Address: Royal W. Craig;Ober, Kaler, Grimes & Shriver, 120 East Baltimore Street, Baltimore, MD, 21202-1643, US

(21) Appl. No.: 11/897,900

(22) Filed: Aug. 31, 2007

Related U.S. Application Data
(60) Provisional application No. 60/841,612, filed on Aug. 31, 2006.

(51) Int. Cl. G06Q 30/00; G06K 19/06

(52) U.S. Cl. 705/14; 235/493

(57) ABSTRACT

A method for movie (or other content) distribution that relies on a pre-paid “film card” and/or download certificate distributed by studios to retailers for purchase by consumers. A customer buys a generic film card from a retailer (or downloads a certificate at home), emblazoned with the graphics of an upcoming release. At purchase the customer specifies their viewing preference and pays accordingly, the film card price reflecting the options that the card will provide (one or more of the following): 1) Buy DVD; 2) Buy Theater ticket; 3) Buy Cable TV (PPV); 4) Rent DVD; 5) Purchase Merchandise. Distribution commences in accordance with a curtailed schedule of release windows range from a five to thirty day release in theaters, followed by release the next Monday at 6 pm to cable/pay-per-view, then the next day to DVD, and from there to TV, etc. This method gives consumers buying simplicity, and gives the studios greater control over releases, reducing bootlegging, pirating and fake ticket sales at theatres.

### CROSS-REFERENCE TO RELATED APPLICATIONS

The present application derives priority from U.S. Provisional Patent Application No. 60/841,612 for “MOVIE DISTRIBUTION METHOD”; Filed Aug. 31, 2006.

### BACKGROUND OF THE INVENTION

1. Field of the Invention

The present invention relates to distribution of movies to theaters, home video, TV, pay-per-view, video-on-demand, hotels, airlines, etc., and more particularly, to a movie distribution method that allows production studios to tap the full potential of each market, without simultaneous competition from other distribution platforms and with increased control, reduced fraud, and more consumer appeal.

2. Description of the Background

Traditionally movies are released in “windows”, first to theaters, then to home video, and from there to TV, pay-per-view, video-on-demand, hotels, airlines and so on. By staggering the availability to each market, studios intend to tap the full potential of each, without simultaneous competition from other distribution markets. A contractual barrier is created called the “video window” which prevents cable operators and TV stations from showing movies at the same time as their release on DVD. In the case of pay-per-view, the normal window is 45 days; with subscription cable such as HBO, it is at least four months. Because 80% of people rent movies the week of their release, most would-be renters have already seen a new release by the time the 45-day window has elapsed. Since some major retailers provide studios with more than one-third of their U.S. DVD revenue, these retailers have substantial market power. Thus far studios have been hesitant to do away with the video window.

Other factions believe that the current distribution methods are not pro-consumer and require change. They want to eliminate windows so that consumers can buy a movie as they wish, where they wish, when they wish. Under this model movies would be made available simultaneously on cable television, DVD, and in movie theaters, letting consumers pay a premium to see new releases at home. Since many established movie studios are unwilling to tackle such change, some studios and independent artists are experimenting. For example, producer Steven Soderbergh has made his movies available on DVD just four days later after release. See, Borrland, “Soderbergh does a DVD-theater release combo”, CNET Talkback Article (Jan. 12, 2006). Twentieth Century Fox has begun releasing movies to video-on-demand services simultaneously with DVD releases. See, Hernandez, “TRIBECA '06: In a Time of Change for the Movie Business, Talking About Emerging Distribution Platforms”, IndiWire.com (Apr. 27, 2006), also, Epstein, “Can You Clone a Movie Star? A report from Hollywood's digital Frontier”, The Hollywood Economist (Mar. 6, 2006).

Of course, consumers don't realize the complexities. They are confronted with a hodge-podge of options and must gain inside information of the movie industry to really understand what their options are, and why they are so limited.

One popular consumer buying approach for other consumer goods is the “gift card”, and their increasing popularity has forced their adaptation by some in the movie business. Some of the larger theater chains such as Hoyts and Loews offer gift cards to their patrons. In addition, United States Patent Application 20040118914 by Smith et al. (e2interactive) published Jun. 24, 2004 shows a system & method for distributing stored-value cards. The method may be used with any type of stored-value card account, and examples include prepaid emergency road service cards, movie cards, etc. However, the gift card value can only be redeemed for movie tickets at specific theaters and does not expand viewer options.

It would be greatly advantageous to provide a movie card that does indeed give consumers more flexible options for using the card to view movies in their preferred format, and indeed to make the movie card an integral part of movie distribution into theater releases, cable, DVD, etc., in order to allow production studios to tap the full potential of each market, without simultaneous competition from other distribution platforms and with increased control, reduced fraud, and more consumer appeal.

### SUMMARY OF THE INVENTION

It is therefore an object of the present invention to provide a method for movie (or other media) distribution based on pre-paid film card sold with a full-array of viewing options, thereby giving consumers more buying simplicity with more flexibility.

It is another object to give movie production studios more control over distribution.

It is still another object to reduce movie bootlegging, pirating and fake ticket sales at theatres.

In accordance with the foregoing objects, the present invention is a method for movie (or other content) distribution that gives consumers the ability to purchase a “film card” with the prepaid option to view new release movies in theaters within a condensed new release window of five (5) to thirty (30) days (the movie may run in the theater longer but the film card option may be exercised within the 5-30 day window), or the option to view the movie beginning the next Monday at 6 pm on cable/pay-per-view, then the next day option by DVD purchase, and from there to TV, etc. The method relies on a pre-paid “film card” distributed in either of two formats: 1) a magnetic swipe car distributed by studios to retailers for purchase by consumers; and/or a downloadable paper certificate bearing a PIN number. If the former, a customer buys a generic film card from a retailer, emblazoned with the graphics of an upcoming release. At purchase the customer specifies their viewing preference and pays accordingly, the film card price reflecting the options that the card will provide (one or more of the following): Buy DVD, Buy Theater ticket, Buy Cable TV (PPV), Rent DVD, Purchase Merchandise. If the latter, a customer buys a downloadable certificate through an online web portal, downloads the certificate, and prints the certificate at home (again emblazoned with the graphics of a specific upcoming release. At purchase the customer specifies their viewing preference and pays accordingly, the film certificate price reflecting the options that the card will provide (as above).

The film card and/or film certificate are redeemable at movie theaters, video stores, retailers, and all distributors of the movie release. The purveyeor simply enters the PIN number by swiping the magnetic card or manual entry. Fractional payments to the retailer, studios and Theaters and Cable companies is transacted automatically by a merchant payment system over a Visa or MasterCard payment network. Though the film card or certificate can be pre-purchased in advance of release, it can only be used by purchasers in accordance with a curtailed schedule of release windows. Specifically, the movie card/certificate may optionally be used within a “new release window” of five to thirty days to view new releases in theaters (or longer, depending on the length of the theater run), and then used beginning the next Monday at 6 pm for a cable/pay-per-view viewing, then the next day to DVD, and from there to TV, etc. Thus, when a customer purchases a DVD the studios ship the DVDs pursuant to the fixed release schedule, direct to customers in one business day based on payment commitment from retailers. Theaters accept activated film card/certificates upon release of the movie, and cable providers will deliver the movie on-demand (pursuant to the fixed release schedule) to customer's home base on code numbers printed on the film card/certificate.

The proposed method gives consumers much more buying simplicity with more flexibility, and gives the studios greater control over releases, reducing bootlegging, pirating and fake ticket sales at theatres.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a general block diagram showing the steps involved in the present method.

FIG. 2 is a table of the various purchase options available to the customer.

FIG. 3 is a front view of the card 1.

FIG. 4 is a rear view of the card 1.

FIG. 5 is a front view of an exemplary download film certificate 20.

### DETAILED DESCRIPTION OF THE PREFERRED EMBODIMENTS

The present invention is a method for movie (or other content) distribution that relies on a pre-paid “film card” 1 distributed by studios to retailers for purchase by consumers. A customer buys a generic film card from a retailer. At purchase the customer specifies their viewing preference from a broad array of options (to be described) and pays accordingly. The film card 1 price reflects the options that the card 1 will provide from among the following general options: Buy DVD, Buy Theater ticket, Buy Cable TV (PPV), Rent DVD, Purchase Merchandise. It is essential that each film card 1 is magnetically coded with a PIN number associating it with a particular movie and indicating the selected purchase options. Moreover, the film cards are pre-printed with graphics reflecting a scene from that movie, such as a promotional poster scene. This gives customers a significant visual impulse-purchase incentive.

As an alternative to the film card, consumers can download a paper film certificate 20 through an online web portal. Again, at purchase the customer specifies their viewing preference and pays accordingly, the film card price reflecting the options that the card will provide (one or more of the above-referenced options). After the online purchase the customer simply downloads the certificate 20, and prints the certificate 20 at home (again emblazoned with the graphics of a specific upcoming release.

The film card and/or film certificate are redeemable at movie theaters, video stores, retailers, and all distributors of the movie release. The purveyor simply enters the PIN number by swiping the magnetic card or manual entry. Fractional payments to the retailer, studios and Theaters and Cable companies is transacted automatically by a merchant payment system over a Visa or masterCard payment network.

Though the film card 1 can be pre-purchased in advance of release, distribution commences in accordance with a curtailed schedule of release windows. Specifically, the new release window can range between a five (5) to thirty (30) day release in theaters, followed by release the next Monday at 6 pm to cable/pay-per-view, then the next day to DVD, and from there to TV, etc. The film card 1 may be purchased in advance but can only be used for movie theaters, rentals and purchases after the respective release windows begin accruing. Thus, when a customer purchases a DVD the studios ship the DVDs pursuant to the fixed release schedule, direct to customers in one business day based on payment commitment from retailers. Theaters accept activated film cards 1 upon release of the movie and during the entire theater run cable providers will deliver the movie on-demand (pursuant to the fixed release schedule) to customer's home base on code numbers printed on the film card 1.

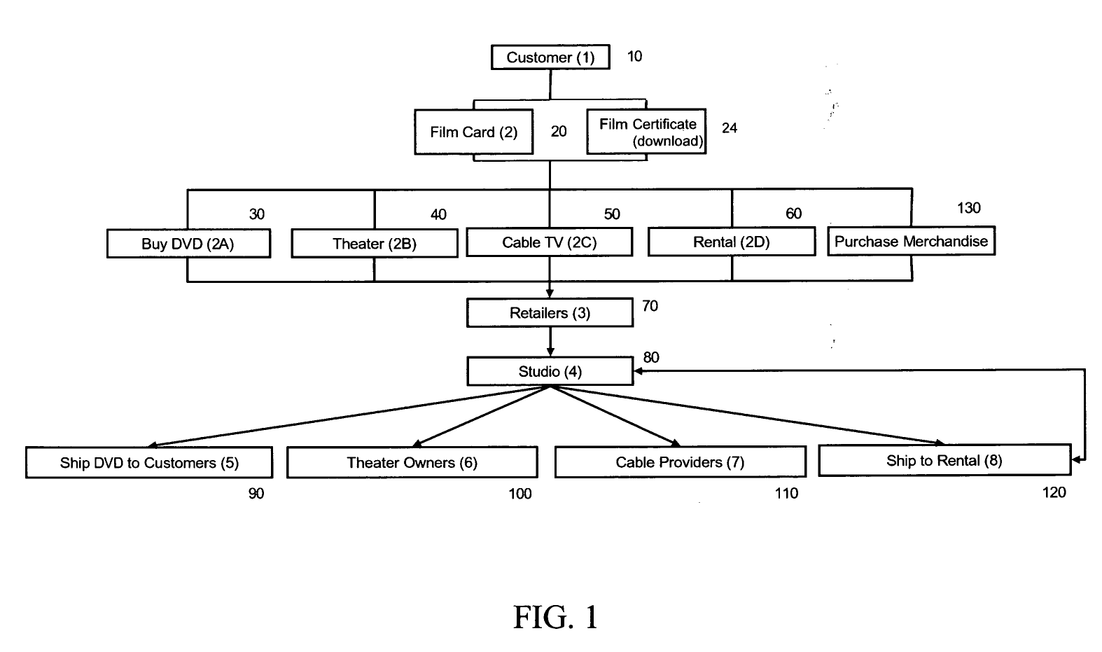

FIG. 1 is a general block diagram showing the steps involved in the present method.

At step 10 a customer enters a retail establishment and, at step 20 chooses to purchase a film card 1. As described below the film cards 1 are supplied by the movie studios and are stocked by retailers more or less as a substitute for a DVD inventory. This greatly reduces the necessary shelf space. Each film card 1 is coded to associate it with a particular movie, and the film cards are pre-printed with graphics reflecting a scene from that movie. This gives customers a significant visual impulse-purchase incentive.

As an alternative to the film card, at step 24 consumers can download a paper film certificate 20 through an online web portal in their own homes.

At checkout at step 30, the customer is given general options (by the cashier or web portal) to buy DVDs (step 30), theater tickets (step 40), cable TV or pay-per-view (step 50), rent DVDs (step 60), or purchase merchandise (step 130). Preferably, these options appear to the cashier or to the customer in the form of a graphical interface on a monitor, which may be read or displayed to the customer. The customer makes his selection from among the general options (30, 40, 50, 60, 130) and is presented with a list of sub-options (to be described). The basic film card 1 carries a base price, and these general options (30, 40, 50, 60, 130) as well as sub-options may increase the base price. The customer makes his selection of sub-option and the cashier collects the corresponding payment at step 70 and activates the card 1 accordingly by swiping it through a magnetic card reader/writer. The card's PIN number is magnetically coded onto the stripe, and this is associated with a customer account containing the purchased options. At step 80 the payment (less a retail margin) is immediately transmitted to the studio that supplied the film card 1, and all payments are transacted automatically by a merchant payment system over a Visa or MasterCard payment network.

In the case of the download film certificate 20, after the online purchase the customer simply downloads the certificate, and prints the certificate at home (again emblazoned with the graphics of a specific upcoming release. The film certificate 20 prints bearing a PIN number. The card's PIN number is associated with a customer account containing the purchased options. Merchant payments are transacted electronically as above.

At steps 90-120 the studio initiates the distribution process in accordance with the selected options/sub-options. Specifically, if the customer has chosen to buy DVDs (at step 30), then at step 90 the studio will hold in abeyance until after the release window (between five (5) to thirty (30) days) for theaters, and will drop-ship the DVD direct to the consumer by overnight mail. If the customer has chosen to view the release in theaters (at step 40), then at step 100 the customer may use their film card 1 and/or certificate 20 at any participating theater to purchase tickets for the release. If the customer has chosen pay-per-view (at step 50), then at step 110 the studio will hold in abeyance until the next Monday at 6 pm (following theater release). The pre-printed film card 1 and/or certificate 20 bears a pay-per-view code which can be entered to initiate cable/pay-per-view, and so long as the card is properly activated the code will work to purchase the pay-per-view screening. If the customer has chosen to rent a DVD (at step 60), then at step 120 the studio will hold in abeyance until after the full thirty (30) day release window for theaters, and will drop-ship the DVD in a returnable envelope direct to the consumer by overnight mail. If the customer has chosen to purchase merchandise (at step 130) then so long as the pre-printed film card 1 and/or certificate 20 is properly activated, it will work to purchase the merchandise.

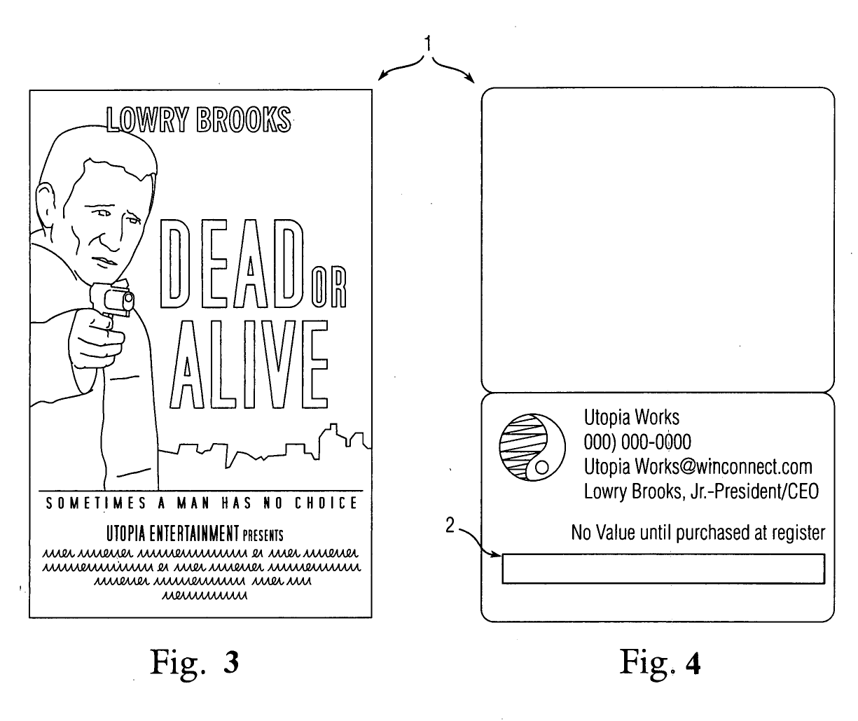

FIGS. 3 and 4 are front and rear views, respectively of the film card 1. The film card 1 used for the present method is an ordinary magnetic stripe card of a type capable of storing data by modifying the magnetism of tiny iron-based magnetic particles on a band of magnetic material on the card. The magnetic stripe 2 is read by physical contact and swiping past a reading head. The magnetic stripe card may conform to any of the existing standards, ISO 7810, ISO 7811, ISO 7812, ISO 7813, and ISO 4909, which define the physical properties of the card 1, including size, flexibility, location of the magnetic stripe 2, and magnetic characteristics. The magnetic stripe 2 is located about 0.223 inches (5.66 mm) from the edge of the card 1 on one side, and is 0.375 inches (9.52 mm) wide. The magnetic stripe 2 contains three tracks, each 0.110 inches (2.79 mm) wide. Tracks one and three are recorded at 210 bits per inch, while track two is at 75 bits per inch. Each track can either contain 7-bit alphanumeric characters, or 5-bit numeric characters. Typically, as shown in FIG. 4, the magnetic stripe 2 is on the back of the card 1. Retail establishment information can also be printed on the back of the card 1, proximate the magnetic stripe 2. FIG. 4 displays, for example, contact information for the retailer Utopia Works. FIG. 3 shows the opposite side (front) of the film card 1, which displays advertisement of a motion picture film available for viewing in the theater, on DVD, on Cable TV, and for rental.

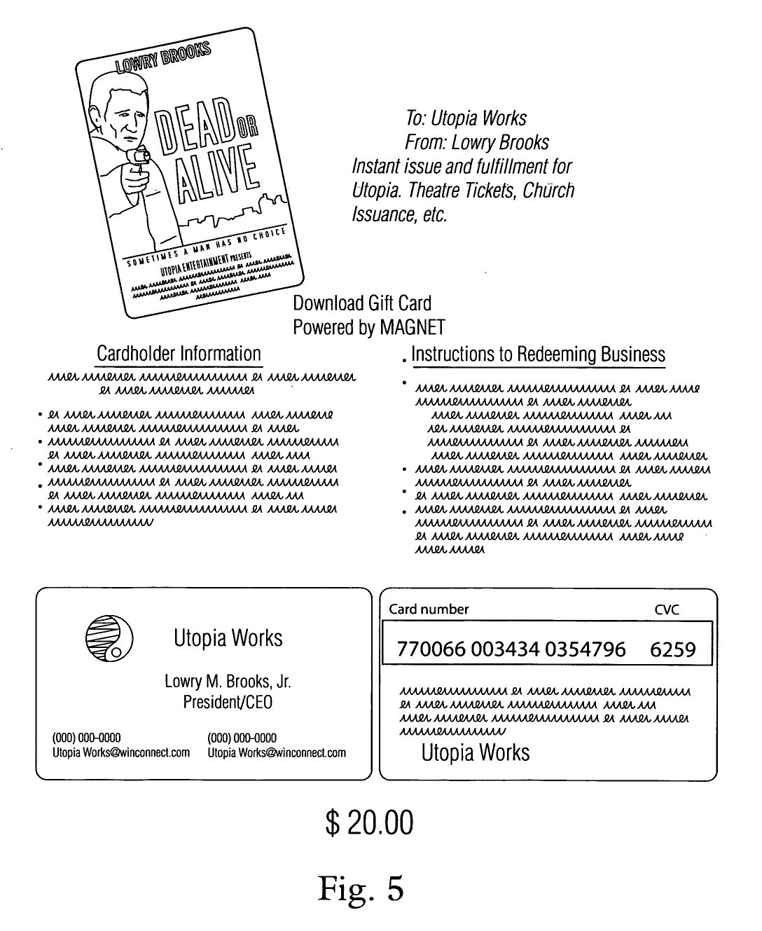

FIG. 5 is a front view of an exemplary download film certificate 20. After the online purchase the customer simply downloads this certificate 20 and prints it out. It is emblazoned with the graphics of the specific upcoming release (top left). The film certificate 20 also prints bearing a designated PIN number (bottom right). The card's PIN number is associated with a customer account containing the purchased options. Merchant payments are transacted electronically as above.

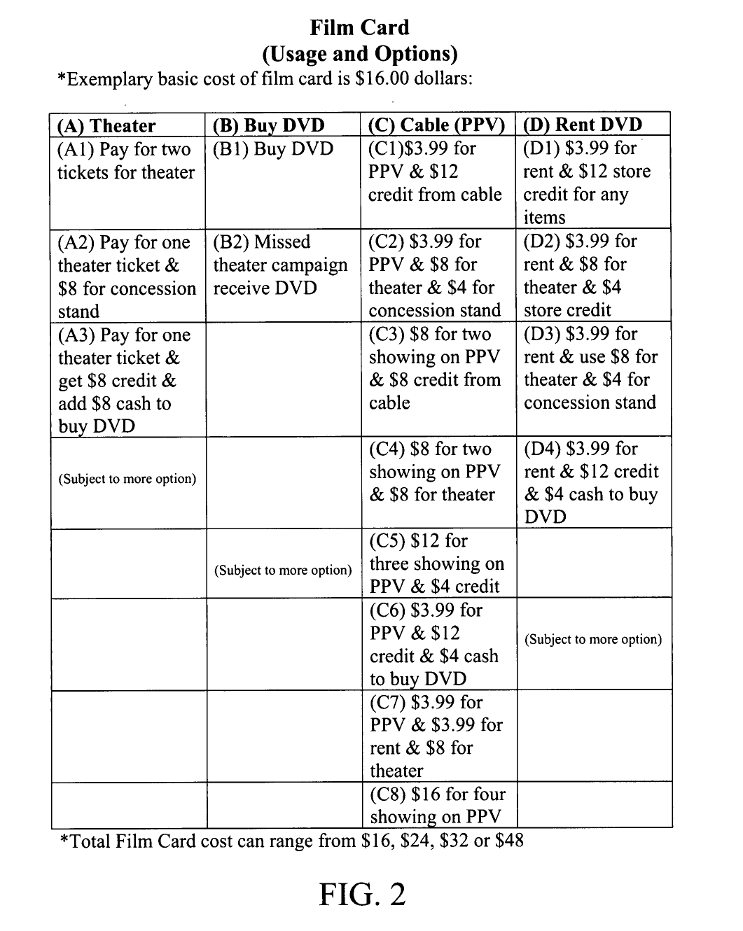

FIG. 2 is a table of the various purchase options available to the customer. Given an exemplary basic cost of the film card 1 of $16.00 dollars, the customer must first select from four general options (A)-(E):
(A) Buy DVD
(B) Buy Theater ticket
(C) Buy Cable TV (PPV)
(D) Rent DVD
(E) Purchase Merchandise

As stated previously, these options appear to the cashier or to the customer in the form of a graphical interface on a monitor, which may be read or displayed to the customer. The customer makes his selection, and which may increase the base price.

For the theater ticket purchase option the base price will (A1) Pay for two tickets for theater; (A2) Pay for one theater ticket plus $8 for concession stand; (A3) Pay for one theater ticket & get $8 credit & leave $8 on the card to buy the DVD. The card will be accepted for up to the full stored value to purchase the corresponding option at all participating theaters.

Customers may arrive at the DVD purchase option (B) in two ways. For those who initially wish to buy they select (B1) Buy DVD. On the other hand, many customers who originally chose to view the movie in theaters (A) may miss the theater run. These customers may select (B2) Missed theater campaign. They likewise receive the DVD by mail.

Customers who prefer pay-per-view (PPV) have a variety of purchase options: (C1)$3.99 for one PPV & $12 credit from cable; (C2) $3.99 for PPV & $8 credit for theater plus $4 for concession stand; (C3) $8 for two showing on PPV & $8 credit from cable; (C4) $8 for two showing on PPV & $8 for theater; (C5) $12 for three showing on PPV & $4 credit (C6) $3.99 for PPV & $12 credit & $4 cash to buy DVD; (C7) $3.99 for PPV & $3.99 for rent & $8 for theater; (C8) $16 for four showing on PPV.

Customers who prefer a DVD rental have the following purchase options: (D1) $3.99 for rent & $12 store credit for any items; (D2) $3.99 for rent & $8 for theater & $4 store credit; (D3) $3.99 for rent & use $8 for theater & $4 for concession stand; (D4) $3.99 for rent & $12 credit & $4 cash to buy DVD.

Customers who prefer to purchase merchandise, such as movie sound tracks, action figures, or other movie paraphernalia can do so with the card 1. The card 1 originally includes $16 worth of merchandise credit. The user can increase the value of the card 1 amount if he so chooses, by paying this additional amount to the cashier at the time of purchasing the card 1.

The most important thing to note with the foregoing purchase options is that until the purchased goods/services are fulfilled, the stored value remains on the card and the customer may exchange the value for other purchase options. This is one of the strongest salient points of the card inasmuch as customers cannot lose their investment as they can with tickets. For example, if the customer initially selects the theater option but misses the initial run in theaters, the card may be redeemed for any of the other options up to the full stored value.

Two final points add to the utility of the above-described method. First all physical inventory (the cards 1) are manufactured and distributed by the movie production studios and all software is licensed from them. Thus, the studios control the distribution and payment flow. Retailers use the software onsite to complete sales and the software automatically remits payment to the studios. The studios must then allocate payment to Theaters and Cable companies when the card is used. Since theaters accept the activated film cards 1 in lieu of paper tickets, the theaters cannot issue false tickets at the gate and studios are assured an exact accounting of actual sales.

It is also very important that the studios adhere to the shortened release windows. Specifically, the release windows can range between a five (5) to thirty (30) day window release in theaters, followed by release the next Monday at 6 pm to cable/pay-per-view, then the next day to DVD, and from there to TV, etc.

The foregoing method of using pre-paid film cards 1 with a full-array of viewing options, clearly gives consumers more buying simplicity with more flexibility, gives studios more control over distribution, and reduces movie bootlegging, pirating and fake ticket sales at theatres.

Having now fully set forth the preferred embodiments and certain modifications of the concept underlying the present invention, various other embodiments as well as certain variations and modifications thereto may obviously occur to those skilled in the art upon becoming familiar with the underlying concept. It is to be understood, therefore, that the invention may be practiced otherwise than as specifically set forth herein.

I claim:

1. A method for content distribution that relies on a pre-paid card, comprising the steps of:
distributing magnetic stripe cards from producers of said content to retailers, each of said magnetic stripe cards being printed with graphics advertising said content;
selling said magnetic stripe cards to customers with prepaid options;
selecting one of said prepaid options;
collecting payment from said customer for said prepaid option that said customer selected;
activating said card by swiping said card through a magnetic card reader/writer; transmitting said payment to said producers of said content;
distributing said content in accordance with said chosen prepaid option and pursuant to a predetermined schedule of release windows range from five to thirty day release live, followed by release the next Monday evening to cable/pay-per-view, then the next day to DVD/CDROM.

2. A method for content distribution according to claim 1, wherein said step of collecting payment from said customer precedes the following step: sending payment to said producers of said content.

3. A method for content distribution according to claim 1, wherein said prepaid options comprise: purchase, observe live event, pay-per-view, and rent.

4. A method for content distribution according to claim 3, wherein said options appear to said customer as a graphical interface on a monitor, which may be read or displayed to said customer.

5. A method for content distribution according to claim 3, wherein said purchase option includes buying a DVD.

6. A method for content distribution according to claim 5, wherein said purchase option further comprises missing viewing said content in theater and then receiving said DVD by mail.

7. A method for content distribution according to claim 5, wherein said producers of said content ship said DVD direct to said customer in one business day pursuant to said predetermined schedule of release windows.

8. A method for content distribution according to claim 3, wherein said purchase option includes buying movie merchandise.

9. A method for content distribution according to claim 3, wherein said observe live event option includes buying a theater ticket.

10. A method for content distribution according to claim 9, wherein said buying a theater ticket is inclusive of: paying for two tickets for theater, paying for one theater ticket plus $8 for concession stand, or paying for one theater ticket and receiving $8 credit and leaving $8 on the card to buy a DVD.

11. A method for content distribution according to claim 3, wherein said pay-per-view option is inclusive of: obtaining one pay-per-view movie for $3.99 and receiving $12 credit from cable, obtaining one pay-per-view movie for $3.99 and $8 credit for theater plus $4 for concession stand, obtaining two pay-per-view movies for $8 and $8 credit from cable, obtaining two pay-per-view movies for $8 and $8 for theater, obtaining three pay-per-view movies for $12 and $4 credit, obtaining one pay-per-view movie for $3.99 and $12 credit and $4 cash to purchase a DVD, obtaining one pay-per-view movie for $3.99 and $3.99 for renting a DVD and $8 for theater, or obtaining four pay-per-movies for $16.

12. A method for content distribution according to claim 3, wherein said rent option includes renting a DVD.

13. A method for content distribution according to claim 12, wherein said pay-per-view option is inclusive of: renting said DVD for $3.99 and obtaining $12 store credit for store items, renting said DVD for $3.99 and obtaining $8 for theater and $4 store credit, renting said DVD for $3.99 and obtaining $8 for theater and $4 for concession stand, or renting said DVD for $3.99 and obtaining $12 credit and $4 cash to purchase another DVD.

14. A method for content distribution according to claim 12, wherein said producers of said content hold said DVD in abeyance until after said five to thirty day release window for theaters and then drop-ship said DVD in a returnable envelope direct to said customer by overnight mail.

15. A method for content distribution according to claim 1, wherein said content is a movie.

16. A pre-paid film card comprising a plastic card having a full-color print advertisement on one side for a particular movie, and a magnetic stripe on another side storing data programmed thereon when a customer purchased said film and said data specifying said customer's viewing preference including any one from among a group consisting of Buy DVD, Buy Theater ticket, Buy Cable TV, Rent DVD, Purchase Merchandise.

17. A film card according to claim 16, wherein said band is located about 0.223 inches (5.66 mm) from edge of said card on one side, further wherein said band is 0.375 inches (9.52 mm) wide.

18. A method for movie distribution, comprising the steps of:
distributing magnetic swipe cards from producers of said content to retailers, each of said magnetic stripe cards being printed with graphics advertising said content;
distributing prepaid movie certificates to consumers via download from an online web portal, each of said prepaid movie certificates being printed with graphics advertising said movie;
selling said magnetic stripe cards and movie certificates to customers with prepaid movie viewing options;
selecting one of said prepaid options;
collecting payment from said customer for said prepaid option that said customer selected;
activating said magnetic swipe cards by swiping said cards through a magnetic card reader/writer;
transmitting said payment to said producers of said content;
distributing said content in accordance with said chosen prepaid option and pursuant to a predetermined schedule of release windows range from five to thirty day release live, followed by release the next Monday evening to cable/pay-per-view, then the next day to DVD/CDROM.

19. A method for content distribution according to claim 18, wherein said step of collecting payment from said customer precedes the following step: sending payment to said producers of said content.

20. A method for content distribution according to claim 18, wherein said prepaid options comprise: purchase, observe live event, pay-per-view, and rent.
